(19) United States
(12) Patent Application Publication
(10) Pub. No.: US 2022/0066304 A1
(43) Pub. Date: Mar. 3, 2022

(54) PROJECTION APPARATUS, INTERACTIVE SYSTEM, AND PROJECTION METHOD

(71) Applicant: Toshinobu KOAKUTSU, Kanagawa (JP)

(72) Inventor: Toshinobu KOAKUTSU, Kanagawa (JP)

(73) Assignee: Ricoh Company, Ltd., Tokyo (JP)

(21) Appl. No.: 17/445,845

(22) Filed: Aug. 25, 2021

(30) Foreign Application Priority Data
Aug. 28, 2020 (JP) 2020-144727

(51) Int. Cl. G03B 21/20

(52) U.S. Cl. CPC G03B 21/206; G03B 21/2033; G03B 21/2013

(57) ABSTRACT

A projection apparatus includes a work state detector configured to detect a state of work of mounting or removing a component; and a light source controller configured to stop emission of light from a light source or reduce brightness of the light emitted by the light source, in response to determining that the state detected by the work state detector is start of the work.

### CROSS-REFERENCE TO RELATED APPLICATION

The present application is based on and claims priority under 35 U.S.C. § 119 to Japanese Patent Application No. 2020-144727, filed on Aug. 28, 2020, the contents of which are incorporated herein by reference in their entirety.

### BACKGROUND OF THE INVENTION

### 1. Field of the Invention

The present invention relates to a projection apparatus, an interactive system, and a projection method.

### 2. Description of the Related Art

Conventionally, in order to prevent glare caused by light emitted from a projection apparatus, there has been developed a projection apparatus that detects a moving object, such as a person, and reduces the brightness of the light. For example, there is disclosed a projection apparatus for capturing an image of a projected image and a moving object with an imaging apparatus, and reducing the brightness of the image projected onto a region corresponding to a head region of the moving object, based on the movement direction and the movement amount of the head region of the moving object detected from the captured image.
Patent Document 1: WO 2013/186994

### SUMMARY OF THE INVENTION

According to one aspect of the present invention, there is provided a projection apparatus including a work state detector configured to detect a state of work of mounting or removing a component; and a light source controller configured to stop emission of light from a light source or reduce brightness of the light emitted by the light source, in response to determining that the state detected by the work state detector is start of the work.

### BRIEF DESCRIPTION OF THE DRAWINGS

FIG. 1 is a first diagram illustrating an example of the hardware configuration of a projector according to an embodiment of the present invention;

FIGS. 2A to 2C are diagrams for depicting a mounting state of an operation control unit cover according to an embodiment of the present invention;

FIG. 3 is a second diagram illustrating an example of the hardware configuration of a projector according to an embodiment of the present invention;

FIGS. 4A to 4C are diagrams for depicting a mounting state of an interactive control unit according to an embodiment of the present invention;

FIG. 5 is a diagram for depicting a mounting state signal according to an embodiment of the present invention;

FIG. 6 is a diagram for depicting a voltage of a mounting state signal according to an embodiment of the present invention;

FIG. 7 is a first diagram illustrating an example of functions of a projector according to an embodiment of the present invention;

FIG. 8 is a first diagram illustrating an example of a flow of a mounting control process according to an embodiment of the present invention;

FIG. 9 is a second diagram illustrating an example of a flow of a mounting control process according to an embodiment of the present invention;

FIG. 10 is a third diagram illustrating an example of a flow of a mounting control process according to an embodiment of the present invention; and

FIG. 11 is a third diagram illustrating an example of the hardware configuration of a projector according to an embodiment of the present invention.

### DESCRIPTION OF THE EMBODIMENTS

In the conventional technology, the imaging apparatus captures the projected image projected by the projection apparatus, but an image of the area near the projection apparatus may not be included in the captured image. Therefore, in the conventional technology, for example, when work is performed to attach a component to the projection apparatus or the like, there is a possibility that a moving object (the operator) is not included in the captured image, and the operator may not be detected. In this case, the conventional technology cannot prevent glare while the work is being performed on the projection apparatus.

A problem to be addressed by an embodiment of the present invention is to prevent the glare while work is being performed with respect to the projection apparatus.

Hereinafter, embodiments of the projection apparatus according to an embodiment of the present invention will be described with reference to the drawings.

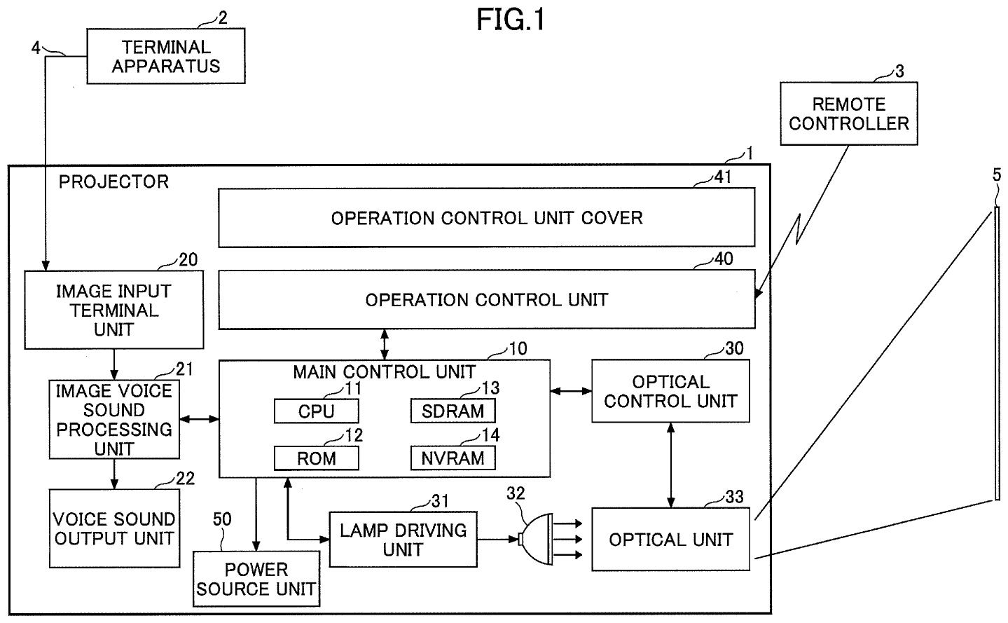

FIG. 1 is a first diagram illustrating an example of the hardware configuration of a projector.

A projector 1 is an example of a projection apparatus that projects an image or a video onto a screen 5 or the like to be displayed.

The projector 1 includes a main control unit 10, an image input terminal unit 20, an image voice sound processing unit 21, a voice sound output unit 22, an optical control unit 30, a lamp driving unit 31, a lamp 32, an optical unit 33, an operation control unit 40, an operation control unit cover 41, and a power source unit 50.

The image input terminal unit 20 is connected to a device such as a terminal apparatus 2 operated by a user. The image input terminal unit 20 includes a High-Definition Multimedia Interface (HDMI (registered trademark)) terminal and a video terminal connected to the output terminal of an audio/video device via a connection cable, a Red-Green-Blue (RGB) terminal connected to the output terminal of a computer device via a connection cable, and the like. For example, the terminal apparatus 2 and the image input terminal unit 20 are connected to each other via an HDMI (registered trademark) cable 4, and the image input terminal unit 20 receives data representing an image displayed on the terminal apparatus 2 and inputs the data to the image voice sound processing unit 21.

The image voice sound processing unit 21 converts the image data input from each device into digital image data of RGB and transmits the converted data to the main control unit 10. The image voice sound processing unit 21 performs D/A (digital-analog) conversion on the voice sound data input from the image input terminal unit 20 or the main control unit 10, and outputs the generated voice sound signal to the voice sound output unit 22.

The voice sound output unit 22 is a speaker or the like that outputs voice sound based on the input voice sound signals.

The main control unit 10 controls various kinds of hardware provided in the projector 1. Specifically, the main control unit 10 includes a Central Processing Unit (CPU) 11, a Read Only Memory (ROM) 12, a Synchronous Dynamic Random Access Memory (SDRAM) 13, and a Non-Volatile Random Access Memory (NVRAM) 14.

The CPU 11 is a main processor that executes various control processes. The ROM 12 is a non-volatile storage device for storing a control program or the like. The SDRAM 13 is a main storage device that temporarily stores data used for processes executed by the CPU 11. The NVRAM 14 is a non-volatile storage device that can record setting information even when the power is turned off.

The main control unit 10 controls the lamp driving unit 31 and the optical control unit 30 in order to display image data transferred from the image voice sound processing unit 21.

The lamp driving unit 31 drives the lamp 32 in response to receiving a request from the main control unit 10. The lamp 32 is driven by the lamp driving unit 31 to emit light toward the screen 5.

The optical control unit 30 controls the optical unit 33 in response to receiving a request from the main control unit 10. The optical unit 33 includes a liquid crystal light valve, a color wheel, a Digital Micromirror Device (DMD), a mirror that reflects image light for displaying an image on the screen 5, a lens for diverging or focusing light by refracting the light, and the like.

The operation control unit 40 includes a keyboard having a plurality of keys and a light emitting diode (LED) for displaying a state. The keyboard includes a power key for turning the power of the projector 1 on or off, a menu key for making various settings, a cursor key, a decision key, an input key for switching the input signal, or the like. The image data representing the contents of various settings and input switching is generated by executing an On Screen Display (OSD) process by the main control unit 10, and the generated image data is projected onto the screen 5.

When any key of the keyboard is pressed, the operation control unit 40 transmits a signal indicating the pressed key to the main control unit 10. A remote controller 3 has keys similar to the keyboard provided in the operation control unit 40 and transmits a signal indicating a pressed key by infrared communication to the operation control unit 40. The operation control unit 40 transmits signals received from the remote controller 3 to the main control unit 10.

The power source unit 50 converts an alternate (AC) current input from a utility power supply, into a direct (DC) current, and supplies power to each piece of hardware of the projector 1. The power source unit 50 is controlled by the main control unit 10.

Further, the operation control unit 40 is adapted to allow a user to mount additional components. The operation control unit cover 41 is a closing tool that closes the mounting portion where a component is mounted to the operation control unit 40.

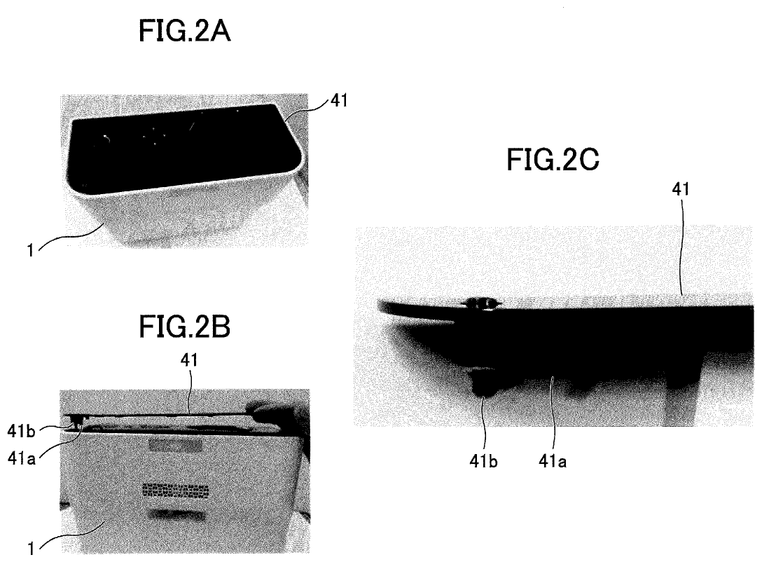

FIGS. 2A to 2C are diagrams for depicting a mounting state of an operation control unit cover. FIG. 2A is a diagram illustrating a state where the operation control unit cover 41 is mounted, FIG. 2B is a diagram illustrating a state where the operation control unit cover 41 is removed, and FIG. 2C is a diagram illustrating an area near a protruding potion.

The operation control unit cover 41 has a protruding portion 41a and a mounting fixture 41b.

The protruding portion 41a pushes a switch provided on the operation control unit 40 when the operation control unit cover 41 is mounted as illustrated in FIG. 2A, and the protruding portion 41a releases the switch when the operation control unit cover 41 is removed as illustrated in FIG. 2B.

The mounting fixture 41b is an instrument for mounting the operation control unit cover 41 to the projector 1 and includes screws, nuts, and the like.

Next, a state in which the operation control unit cover 41 is removed from the projector 1 and an interactive control unit 60 as an example of an alternative component is mounted to the projector 1, will be described.

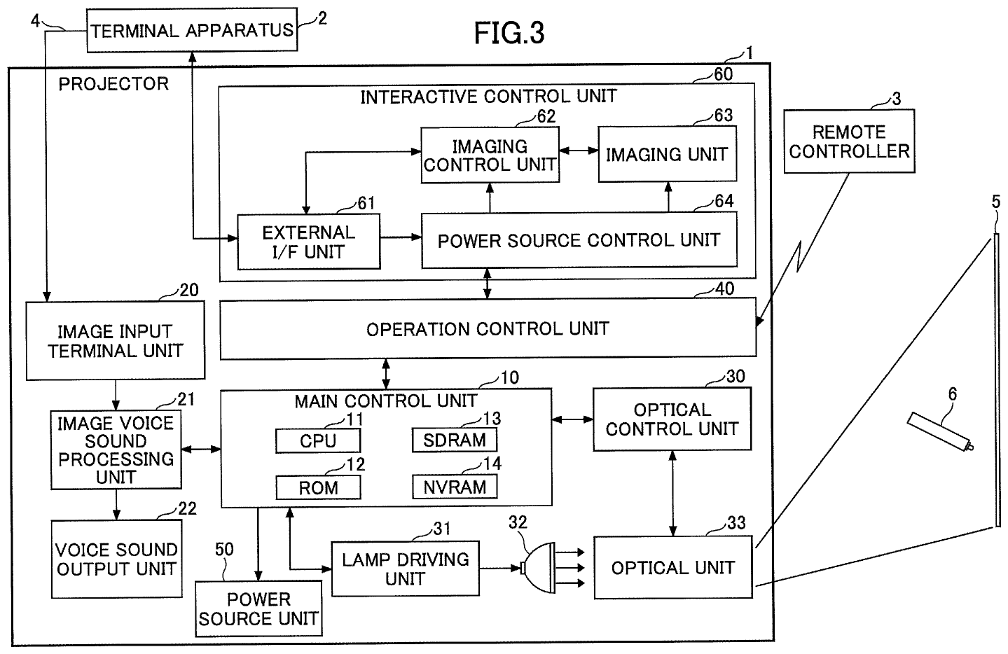

FIG. 3 is a second diagram illustrating an example of the hardware configuration of the projector.

The interactive control unit 60 transmits information representing the operation content of an interactive pen 6, to the terminal apparatus 2. Accordingly, the terminal apparatus 2 implements the same operation contents as operations with respect to a mouse.

Specifically, the interactive control unit 60 includes an external interface (I/F) unit 61, an imaging control unit 62, an imaging unit 63, and a power source control unit 64.

The external I/F unit 61 controls communication with the terminal apparatus 2 via a Universal Serial Bus (USB) cable or the like.

The power source control unit 64 controls the power source of the interactive control unit 60. Specifically, when the external I/F unit 61 is connected with the terminal apparatus 2, the power source control unit 64 supplies power supplied from the projector 1 via the operation control unit 40, to the imaging control unit 62 and the imaging unit 63.

The imaging unit 63 includes an imaging device such as an image sensor and captures a moving image in which the screen 5 is in the capturing range. The interactive pen 6 is an operation instruction device, and when the tip of the interactive pen 6 is pressed against the screen 5, a switch provided at the tip of the interactive pen 6 is turned ON so that the interactive pen 6 emits infrared light.

The imaging control unit 62 detects infrared light from the captured moving image. Specifically, the imaging control unit 62 extracts position information representing the position of the infrared light and data representing the time period from when the interactive pen 6 is switched ON, from the moving image, and transmits the extracted data to the terminal apparatus 2 via the external I/F unit 61. Accordingly, the terminal apparatus 2 recognizes the same operations as those with respect to a mouse (single click, double click, continuous click, etc.) and implements the same functions as those in a case when the mouse is operated.

In this manner, an interactive system including the projector 1 to which the interactive control unit 60 is mounted, the terminal apparatus 2, the screen 5, and the interactive pen 6 is implemented.

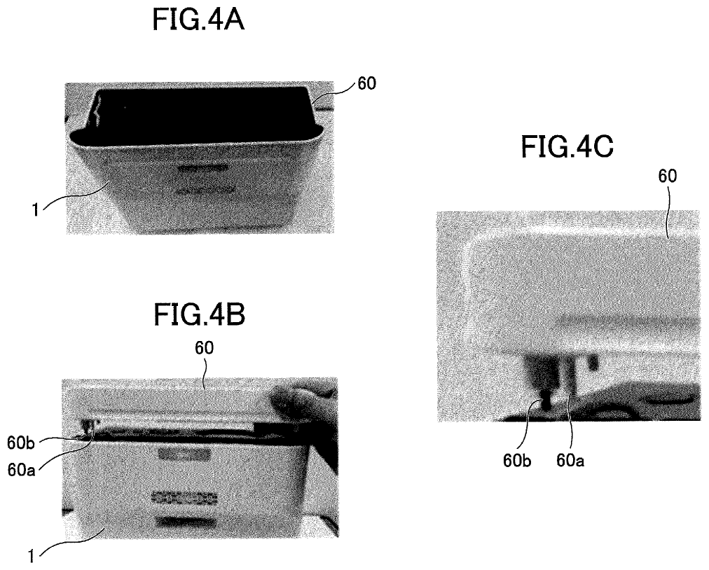

FIGS. 4A to 4C are diagrams for depicting a mounting state of the interactive control unit 60. FIG. 4A is a diagram illustrating a state where the interactive control unit 60 is mounted, FIG. 4B is a diagram illustrating a state where the interactive control unit 60 is removed, and FIG. 4C is a diagram illustrating an area near a protruding potion.

Similar to the operation control unit cover 41, the interactive control unit 60 includes a protruding portion 60a and a mounting fixture 60b.

The protruding portion 60a pushes a switch provided on the operation control unit 40 when the interactive control unit 60 is mounted as illustrated in FIG. 4A, and the protruding portion 60a releases the switch when the interactive control unit 60 is removed as illustrated in FIG. 4B.

The mounting fixture 60b is an instrument for mounting the interactive control unit 60 to the projector 1 and includes screws, nuts, and the like.

The switch provided on the operation control unit 40 transmits a mounting state signal to the main control unit 10 when pressed by the protruding portion 41a of the operation control unit cover 41 or the protruding portion 60a of the interactive control unit 60.

FIG. 5 is a diagram for depicting a mounting state signal.

A switch 40a provided in the operation control unit 40 has one end connected to ground and the other end connected to a power source Vcc via a pull-up resistor R. Thus, the operation control unit 40 transmits a low-level mounting state signal when the switch 40a is connected, and transmits a high-level mounting state signal by the pull-up resistor R when the switch 40a is disconnected.

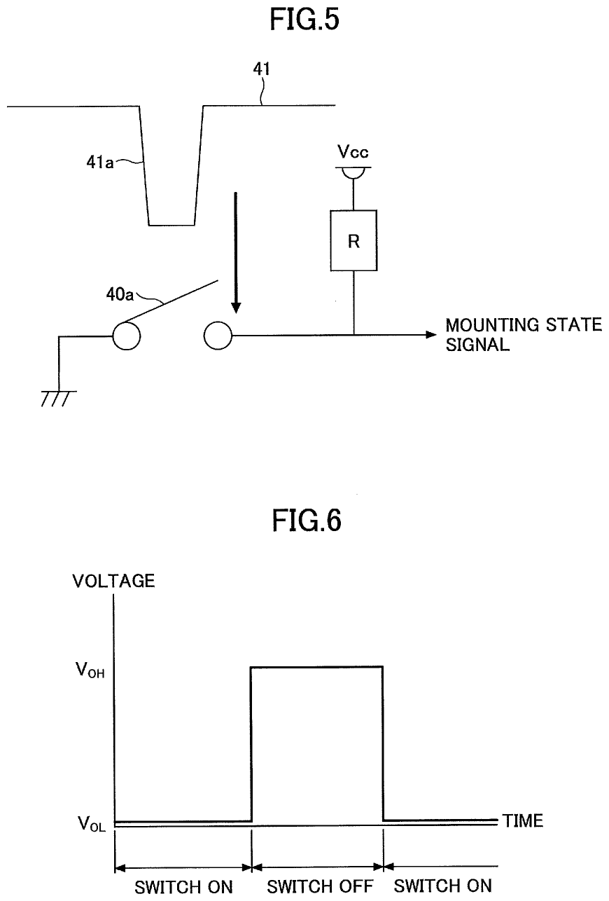

FIG. 6 is a diagram for depicting the voltage of the mounting state signal.

When the operation control unit cover 41 or the interactive control unit 60 is mounted, the switch 40a is turned on (connected state) and the mounting state signal becomes V_{OL} that corresponds to a low-level voltage. The V_{OL} is, for example, approximately 0 V.

When the operation control unit cover 41 or the interactive control unit 60 is removed, the switch 40a is turned off (disconnected state) and the mounting state signal becomes V_{OH} that corresponds to a high-level voltage. The V_{OH} is, for example, a power supply voltage of a general purpose integrated circuit (IC) of approximately 3.3 V or approximately 5.0 V.

Next, the functions of the projector 1 will be described.

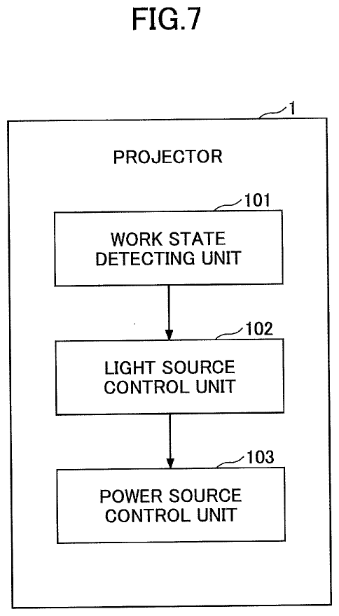

FIG. 7 is a diagram illustrating an example of the functions of the projector 1.

The projector 1 includes a work state detecting unit 101, a light source control unit 102, and a power source control unit 103.

The work state detecting unit 101 detects the state of work with respect to the projector 1. The work on the projector 1 may be, for example, mounting a component to the projector 1 or removing a component from the projector 1. Specifically, the work state detecting unit 101 detects the work state according to the attachment or detachment of the operation control unit cover 41 that closes the mounting portion of a component. Further, the work state detecting unit 101 detects the work state according to the attachment or detachment of the interactive control unit 60 that is a mountable and removable component.

The work state detecting unit 101 detects the removal of the operation control unit cover 41 or the interactive control unit 60, as the start of the work. The work state detecting unit 101 detects the mounting of the operation control unit cover 41 or the interactive control unit 60, as the end of the work.

The work state detecting unit 101 is implemented by the switch 40a provided in the operation control unit 40, and the protruding portion 41a of the operation control unit cover 41 or the protruding portion 60a of the interactive control unit 60, or the like.

The light source control unit 102 stops the light emission from the light source when the state detected by the work state detecting unit 101 is the start of work. This is to prevent glare while the work is being performed. The light source control unit 102 is implemented by the CPU 11 and the lamp driving unit 31.

When the state detected by the work state detecting unit 101 is the start of work, the power source control unit 103 stops the power supply from the power source to the projector 1. The power source control unit 103 is implemented by the main control unit 10 and the power source unit 50.

Next, the operation of the projector 1 will be described.

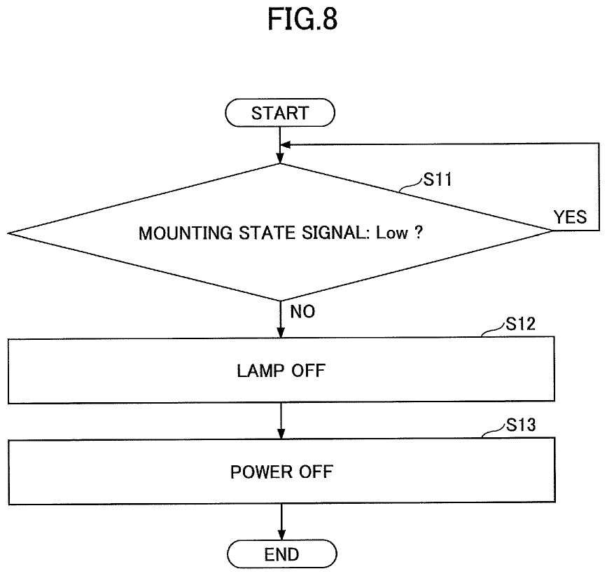

FIG. 8 is a first diagram illustrating an example of the flow of a mounting control process.

When the power source is turned on, the projector 1 starts the mounting control process. In step S11, the work state detecting unit 101 determines whether the mounting state signal is low (low level). In this step, the work state detecting unit 101 acquires a mounting state signal indicating the state of the work of mounting or removing a component.

When it is determined that the mounting state signal is low according to the work state detecting unit 101 (YES in step S11), the process of step S11 is executed again.

In a state where the operation control unit cover 41 or the interactive control unit 60 is mounted, the mounting state signal is low.

When the working state detecting unit 101 determines that the mounting state signal is not low (NO in step S11), the light source control unit 102 turns the lamp off (step S12). Specifically, the main control unit 10 stops the driving of the lamp 32 by the lamp driving unit 31.

In a state where the operation control unit cover 41 or the interactive control unit 60 is removed, the mounting state signal is high.

Next, in step S13, the power source control unit 103 turns off the power source. Specifically, the main control unit 10 controls the power source unit 50 to stop the supply of power from the power source unit 50.

According to the projector 1 of the present embodiment, when the operation control unit cover 41 or the interactive control unit 60 is removed in order for the user to start the work of mounting or removing a component, the lamp is turned off. This prevents glare and temporary loss of vision while performing the work.

Further, according to the projector 1 of the present embodiment, the lamp is turned off and the power is turned off. This allows the user to work safely.

Further, instead of performing the operation of turning the lamp off, only the power may be turned off. Specifically, the light source control unit 102 skips step S12 in the mounting control process illustrated in FIG. 8, and the power source control unit 103 executes the process of step S13. In this case also, the lamp can be turned off by turning the power off, and, therefore, it is assumed that the power source control unit 103 functions as the light source control unit 102 and turns off the lamp.

If glare during the work can be prevented, the light source control unit 102 may reduce the brightness of the light emitted from the light source, instead of stopping the light emission from the light source.

### First Modified Example

In the above described embodiment, instead of turning the power off, the power source may remain on, and when the mounting state signal becomes low, the lamp may be turned on. In this case, if the brightness of the light emitted by the lamp had been reduced, the brightness of the light may be increased.

Specifically, when the work state detecting unit 101 detects that the work has ended, the light source control unit 102 starts the light emission from the light source that had been stopped or increases the brightness of the light emitted from the light source that had been reduced.

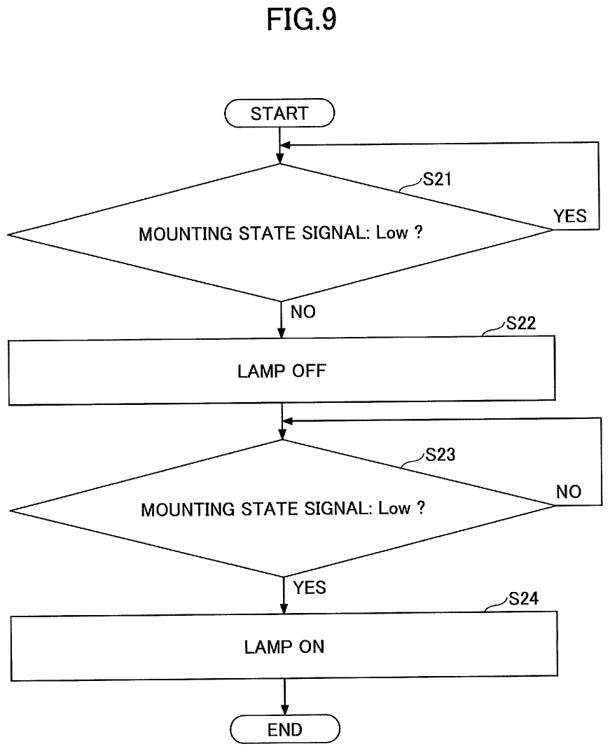

FIG. 9 is a second diagram illustrating an example of the flow of the mounting control process.

Step S21 and step S22 of the mounting control process according to the present modified example are similar to step S11 and step S12 of the mounting control process illustrated in FIG. 8.

Following step S22, in step S23, the work state detecting unit 101 determines whether the mounting state signal is low. If it is determined that the mounting state signal is not low (NO in step S23), the work state detecting unit 101 executes the process of step S23 again.

If the working state detecting unit 101 determines that the mounting state signal is low (YES in step S23), in step S24, the light source control unit 102 turns the lamp on. Specifically, the main control unit 10 starts the driving of the lamp 32 by the lamp driving unit 31.

If the brightness of the light emitted by the lamp had been reduced in the process of step S22, the light source control unit 102 may increase the brightness of the light in the process of step S24.

According to the projector 1 according to the present modified example, if the operation control unit cover 41 or the interactive control unit 60 is mounted in order for the user to finish the work of mounting or removing a component, the lamp is turned on. Accordingly, the user does not have to perform an operation of turning on the power or the lamp after finishing the work, and, therefore, the convenience can be improved.

### Second Modified Example

In the above-described first modified example, instead of immediately turning on the lamp when the mounting state signal becomes low, the lamp may be turned on when a predetermined time elapses after the mounting state signal becomes low. In this case also, if the brightness of the light emitted by the lamp had been reduced, the brightness of the light may be increased.

Specifically, when a predetermined time elapses after the work state detecting unit 101 detects the end of the work, the light source control unit 102 causes the light, that had been stopped, to be emitted from the light source, or causes the brightness of light emitted from the light source, that had been reduced, to be increased.

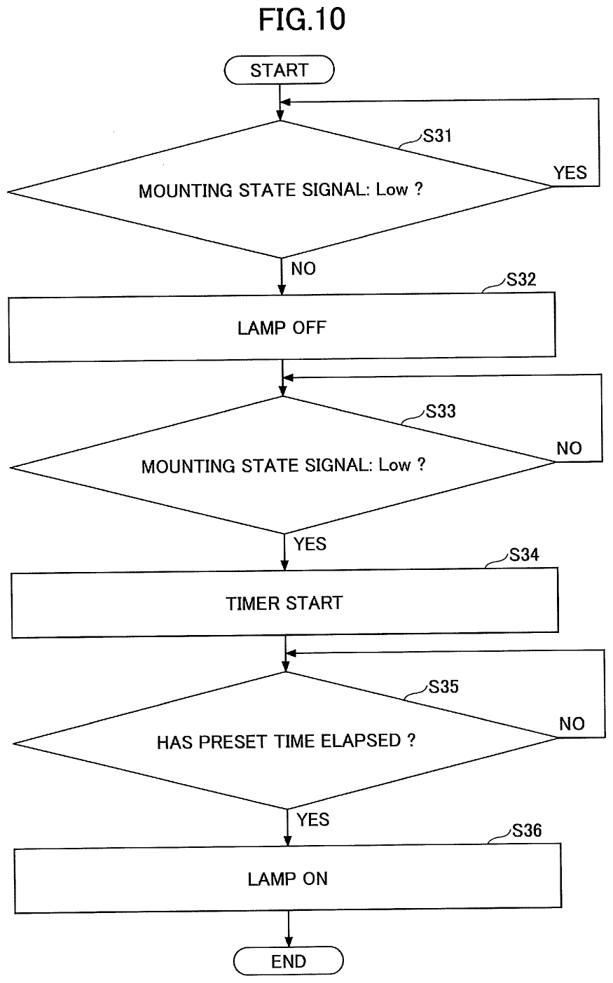

FIG. 10 is a third diagram illustrating an example of the flow of the mounting control process.

The processes from step S31 to step S33 of the mounting control process according to the present modified example is the same as the processes from step S21 to step S23 of the mounting control process illustrated in FIG. 9.

If the working state detecting unit 101 determines that the mounting state signal is low in step S33 (YES in step S33), in step S34, the light source control unit 102 starts a timer. In step S35, the light source control unit 102 determines whether a preset time has elapsed after the timer had started.

For example, this preset time is set to be one minute, as the time required for the work of mounting the mounting fixture 41b of the operation control unit cover 41 or the mounting fixture 60b of the interactive control unit 60.

If it is determined that the preset time has not elapsed (NO in step S35), the light source control unit 102 executes the process of step S35 again.

If it is determined that the preset time has elapsed (YES in step S35), the light source control unit 102 turns on the lamp (step S36).

If the brightness of the light emitted by the lamp had been reduced in the process of step S32, the light source control unit 102 may increase the brightness of the light in the process of step S36.

According to the projector 1 of the present modified example, when a predetermined time has elapsed after the operation control unit cover 41 or the interactive control unit 60 has been mounted in order for the user to finish the work of mounting or removing a component, the lamp is turned on. This prevents the inconvenience in which the lamp is turned on and the user feels glare, while the user is performing work such as attaching the operation control unit cover 41 or the interactive control unit 60 and fixing the screws and the like.

### Third Modified Example

In the embodiments and modified examples described above, the light source may be a laser light source rather than a lamp.

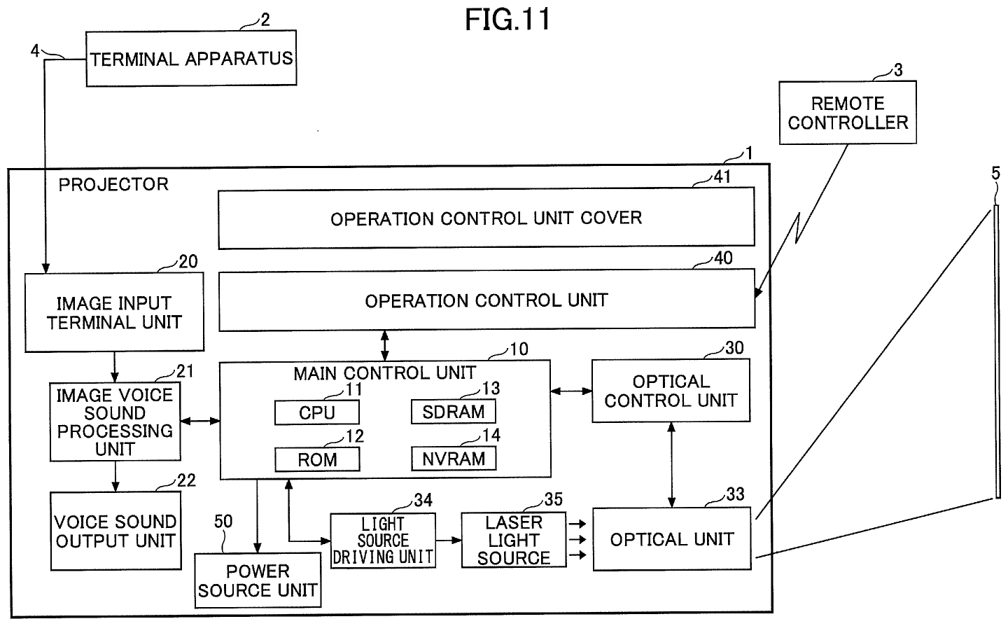

FIG. 11 is a third diagram illustrating an example of the hardware configuration of a projector.

The projector 1 according to the present modified example includes a light source driving unit 34 and a laser light source 35 instead of the lamp driving unit 31 and the lamp 32.

The light source driving unit 34 drives the laser light source 35 in response to receiving a request from the main control unit 10. The laser light source 35 is driven by the light source driving unit 34 to emit laser light toward the screen 5. Laser light includes red, green and blue laser light.

In this case also, the light source control unit 102 is implemented by the main control unit 10 and the light source driving unit 34, and performs the operations described in the above-described embodiments and modified examples. If the light source is a laser, it is highly necessary to turn the light source off or reduce the brightness of the laser light while the user is performing work, because the laser will cause significant damage on the user's eyes.

The group of devices described in each embodiment represents only one of a plurality of computing environments for carrying out the embodiments disclosed herein.

In some embodiments, the terminal apparatus 2 may be configured as an information processing system including a plurality of computing devices such as a server cluster. The plurality of computing devices are configured to communicate with each other via any type of communication link, including networks, a shared memory, and the like, and may perform the processes disclosed herein.

The functions of each of the embodiments described above may be implemented by one or more processing circuits. As used herein, a “processing circuit” includes a processor programmed to execute each function by software such as a processor implemented in an electronic circuit; or devices such as an Application Specific Integrated Circuit (ASIC) a digital signal processor (DSP), a field programmable gate array (FPGA), and a conventional circuit module, designed to execute each function as described above.

According to one embodiment of the present invention, glare can be prevented while work is being performed with respect to a projection apparatus.

The projection apparatus, the interactive system, and the projection method are not limited to the specific embodiments described in the detailed description, and variations and modified examples may be made without departing from the spirit and scope of the present invention.

What is claimed is:

1. A projection apparatus comprising:
a work state detector configured to detect a state of work of mounting or removing a component; and
a light source controller configured to stop emission of light from a light source or reduce brightness of the light emitted by the light source, in response to determining that the state detected by the work state detector is start of the work.

2. The projection apparatus according to claim 1, further comprising:
a power source controller configured to stop supply of power from a power source to the projection apparatus, in response to determining that the state detected by the work state detector is start of the work.

3. The projection apparatus according to claim 1, wherein the light source controller starts the emission of the light from the light source that had been stopped or increases the brightness of the light emitted by the light source that had been reduced, in response to determining that the state detected by the work state detector is end of the work.

4. The projection apparatus according to claim 1, wherein the light source controller starts the emission of the light from the light source that had been stopped or increases the brightness of the light emitted by the light source that had been reduced, in response to determining that a predetermined time has elapsed after the work state detector detects end of the work.

5. The projection apparatus according to claim 1, wherein the work state detector detects the state of the work according to attachment or detachment of a closing tool configured to close a mounting portion where the component is mounted.

6. The projection apparatus according to claim 5, further comprising:
a mountable component configured to be mounted to the projection apparatus, instead of the closing tool, wherein
the work state detector detects the state of the work according to attachment or detachment of the mountable component.

7. An interactive system comprising:
a projection apparatus;
a terminal apparatus; and
an operation instruction device, wherein
the projection apparatus includes:
an interactive controller configured to detect an infrared light emitted by the operation instruction device and transmit position information representing a position of the infrared light to the terminal apparatus;
a work state detector configured to detect a state of work of mounting or removing the interactive controller; and
a light source controller configured to stop emission of light from a light source or reduce brightness of the light emitted by the light source, in response to determining that the state detected by the work state detector is start of the work, and wherein
the terminal apparatus is configured to receive the position information representing the position of the infrared light, and to implement a content of an operation based on the received position information.

8. A projection method executed by a projection apparatus, the projection method comprising:
detecting a state of work of mounting or removing a component; and
stopping emission of light from a light source or reducing brightness of the light emitted by the light source, in response to determining that the detected state is start of the work.
